(19) United States
(12) Patent Application Publication
(10) Pub. No.: US 2024/0357714 A1
(43) Pub. Date: Oct. 24, 2024

(54) ASSEMBLY AND METHOD FOR PROTECTION OF INDUCTION HOBS AND INDUCTION HOB COMPRISING SUCH PROTECTION ASSEMBLY

(71) Applicant: BRETON S.P.A., Castello di Godego (TV) (IT)

(72) Inventors: Angelo DONI, Verona (VR) (IT); Fabrizio DUGHIERO, Padova (PD) (IT); Manuel ZORDAN, Cogollo del Cengio (VI) (IT); Marcello TONCELLI, Bassano del Grappa (VI) (IT)

(21) Appl. No.: 18/579,128

(22) PCT Filed: Jul. 13, 2022
(86) PCT No.: PCT/IB2022/056444

§ 371 Date: Jan. 12, 2024

(30) Foreign Application Priority Data
Jul. 16, 2021 (IT) 102021000018866

(51) Int. Cl. H05B 6/06; H05B 6/08

(52) U.S. Cl. CPC H05B 6/062; H05B 6/08; H05B 2213/04; H05B 2213/06

(57) ABSTRACT

Protection assembly (10) for preventing overheating of induction hobs (1) comprising at least one inductor (4) located underneath a cooking area (6) of the hobs (1). the assembly (10) comprising at least one electric power supplier (8) for the electrically powering the at least one inductor (4) and a control unit (11) connected to the at least one power supplier (8). The control unit (11) is configured to determine at least one value (V) of the intensity gradient of the current over time which supplies the at least one inductor (4). to compare the value (V) of the current intensity gradient over time with a threshold value (VSET) of the current intensity gradient over time and to interrupt or reduce the electric power supply to the at least one inductor (4) if the value (V) of the current intensity gradient is lower than the threshold value (VSET). The invention also relates to an induction hob (1) comprising the protection assembly (10) and to a protection method for preventing overheating of induction hobs (1).

The present invention relates to the technical field of devices for cooking food and in particular relates to an assembly for protection of induction hobs, in particular for preventing overheating of such induction hobs.

The present invention also relates to an induction hob comprising such a protection assembly and a protection method for preventing overheating of induction hobs.

For some time, in the field of devices and electric household appliances for cooking food, hobs for heating and cooking food by means of magnetic induction have been known.

Generally, induction hobs are flush mounted inside a seat (hole or recess) formed in a worktop of the kitchen and comprise one or more inductors associated with respective electric power supply circuits.

The inductors are positioned underneath the bottom surface of the hob at the respective cooking areas; the cooking elements containing the food to be cooked, namely, the saucepans or frying pans, are supported on the top surface of the hob at the cooking areas.

The bottoms of the saucepans or frying pans are made of ferromagnetic material so that the electric powering of the inductors generates an electromagnetic field inside them.

The electromagnetic field in turn generates induced currents which cause heating of the bottom of the saucepans or frying pans by means of the Joule effect, while the food contained inside the saucepans or frying pans are heated by means of conduction.

One drawback of these solutions is that the hob, in particular the areas of the hob in contact with the cooking elements, tends to overheat as a result of thermal conduction.

The overheating may result in the hob breaking or being damaged.

This drawback arises mainly with particular types of cooking, for example:
cooking with a pressure cooker at a temperature of between 120° C. and 130° C.;
frying with vegetable oil at a temperature higher than 165° C.;
cooking with extra virgin olive oil having a smoke point at a temperature of about 210° C.;
grilling on a steak grill at a temperature higher than 200° C.

In order to overcome at least partially this drawback, generally glass ceramic is used as material for making the hobs.

This material has the following special characteristics:
it is a non-magnetic or diamagnetic-and therefore non-ferromagnetic-material and is not affected by magnetic induction;
it has a good resistance to high temperatures of up to 700° C.;
it has a low thermal expansion coefficient;
it is resistant to impacts and/or to corrosive substances.

Glass-ceramic hobs preferably have a thickness of about 4.5 mm in order to obtain the aforementioned special characteristics.

Furthermore, the aforementioned hobs may also have control systems or assemblies comprising one or more temperature sensors, for example NTC probes, which are located in the centre of the inductors and in contact with the bottom surface of the hob.

These control systems prevent the functioning of the magnetic induction system, preferably interrupting the electric power supply to the inductors, when the hob reaches a critical temperature.

In the context of the present description, the expression “critical temperature” indicates the temperature at which the hob overheats, with the consequent risk of breakage or damage.

Even though the technical solutions mentioned above are widespread in the market, they are unable to eliminate completely the risk of breakage or damaging of the hob following overheating thereof.

Furthermore, induction hobs also made of materials other than glass ceramic have been developed.

One example consists of sintered stone, a material known by the tradename Lapitec®, which is generally marketed as an article in slab form composed of mineral aggregates of the ceramic type compacted by means of vacuum vibrocompression and sintered, after drying, to temperatures higher than 1000° C.

This material has a thermal expansion coefficient of about 5 μm/m° C. and has a critical temperature of about 176° C. with particular reference to its use as an induction hob.

Therefore, unlike glass ceramic, the use of sintered stone, for example Lapitec®, for performing induction cooking procedures at temperatures higher than 176° C. is somewhat critical.

Moreover, in order to provide the hob with a satisfactory mechanical strength, the slabs of sintered stone such as Lapitec®, used to make hobs preferably have a thickness of about 12 mm.

WO2019130180 discloses an induction hob made of Lapitec® and comprising a control assembly or system of the type described above.

This document describes also the use of a removable protective element made of insulating material and intended to be arranged between the hob and the bottom of the saucepans or frying pans.

This arrangement allows the hob to be isolated thermally from the heated bottom of the saucepans or frying pans and the hob to be kept at a temperature lower than the critical temperature during cooking of the food, irrespective as to the type of cooking.

This solution also, although widespread in the market, is not without certain drawbacks.

The main drawback consists in the fact that the greater thickness of the hob made of Lapitec® compared to the thickness of glass-ceramic hobs results in a delay in the detection of the temperature reached by the saucepans and the frying pans during cooking of the food, and therefore a delay in the detection, by the control assembly or system, of the critical temperature reached by the hob.

This delay may cause overheating, and therefore breakage or damaging, of the Lapitec® hob before the control assembly or system is able to intervene, for example by interrupting the electric power supply to the inductors.

This drawback may occur both during the usual cooking procedures and during the performance tests carried out on the hob, such as the test which involves heating of four empty saucepans with the hob initially at room temperature and the test which involves heating a saucepan filled with a predetermined quantity of oil.

The main object of the present invention is therefore to provide an assembly and a method for protection of induction hobs and an induction hob comprising such protection assembly, which are able to solve the aforementioned drawbacks.

A particular task of the present invention is to provide an assembly and a method of the aforementioned type which are able to prevent overheating of the hobs and therefore breakage or damaging thereof.

A further task of the present invention is to provide an assembly and a method of the type indicated above which allow various types of cooking of food to be carried out using the induction hob in safe conditions.

Another task of the present invention is to provide a protection method which does not require removable protection elements to be used in combination with the cooking elements.

A further task of the present invention is to provide an assembly and a method of the type indicated above which are able to pass the performance test which involves heating four empty saucepans without the hob overheating and therefore breaking or being damaged.

A further task of the present invention is to provide an assembly and a method of the type indicated above which are able to pass the performance test which involves heating a saucepan filled with oil without the hob overheating and therefore breaking or being damaged.

A further task of the present invention is to provide an assembly and a method of the type indicated above which are able to adjust or interrupt the electric power supply to the inductors before the hob reaches the critical temperature and overheats.

A further task of the present invention is to provide a protection assembly of the type indicated above which may be used in combination with various types of induction hobs.

A further task of the present invention is to provide an assembly and a method of the type indicated above which avoids the risk of scalding for the user following contact with the hob.

The object and the tasks described above are achieved with a protection assembly for induction hobs according to claim 1, with a protection method for preventing overheating of induction hobs according to claim 10, and with an induction hob according to claim 9.

In order to illustrate more clearly the innovative principles of the present invention and its advantages compared to the prior art, an example of embodiment of an induction hob provided with protection assembly and a respective method for protection of the induction hob will be described below with the aid of the attached drawings. In particular:

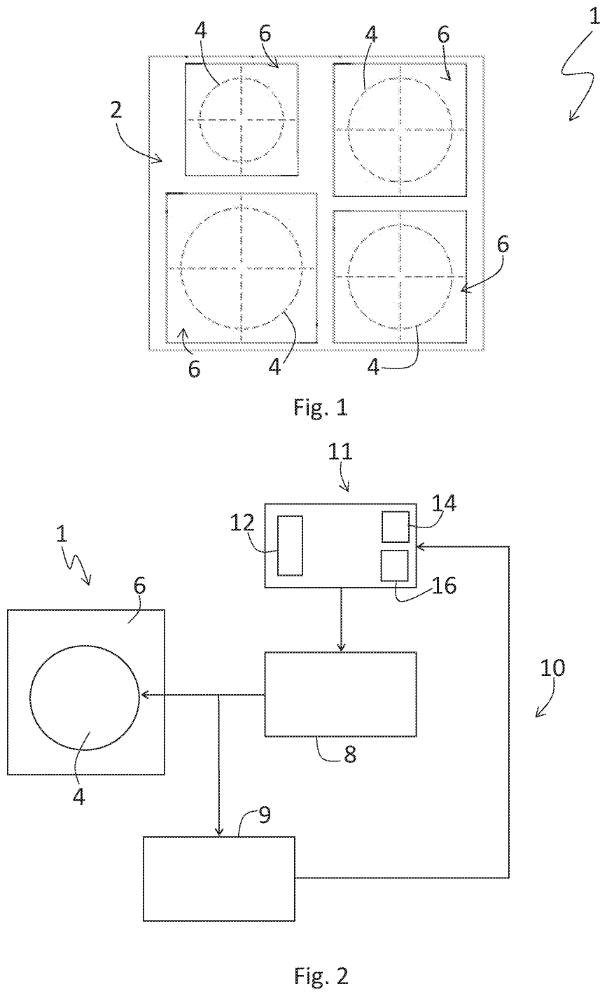

FIG. 1 shows a top plan view of a possible embodiment of the induction hob according to the present invention;

FIG. 2 shows a schematic block diagram of the induction hob with protection assembly according to the present invention;

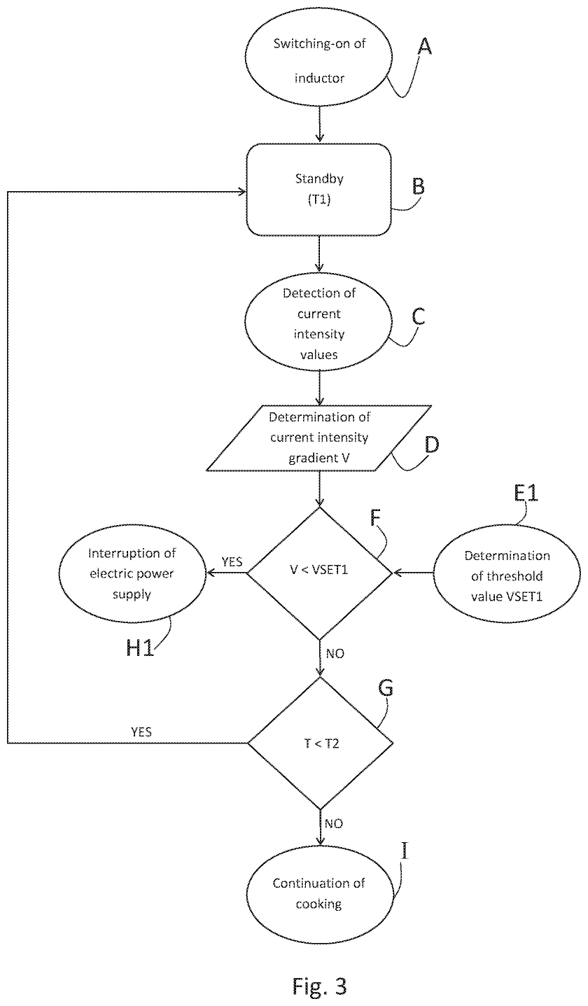

FIGS. 3, 4 and 5 show three flow diagrams relating to three embodiments of the protection method for preventing overheating of the induction hobs.

The present invention, which is provided solely by way of a non-limiting example of the scope of the invention, relates to an assembly for protection of induction hobs, in particular for preventing overheating of induction hobs.

Moreover, the present invention relates to an induction hob comprising said protection assembly and a protection method for preventing overheating of induction hobs.

An example of embodiment of the induction hob is shown in FIG. 1; the protection assembly is shown schematically in FIG. 2 in combination with the hob.

With reference to the aforementioned figures, the hob is denoted overall by the reference number 1, while the protection assembly is denoted overall by the reference number 10.

The induction hob 1 according to the present invention is designed to perform different types of food cooking; these cooking types vary from each other in particular as regards the heating temperatures of the cooking elements and therefore of the food to be cooked.

In the context of the present description, the expression “cooking element” indicates saucepans and frying pans, not shown in the attached figures, containing food and positioned on the top surface 2 of the hob 1.

In a manner known per se, the cooking hob 1 comprises at least one inductor 4 with a respective power supply circuit situated underneath the bottom surface of the hob 1 at a cooking area 6 and the protection assembly 10, which is described in detail below.

The embodiment of the induction hob shown in FIG. 1 shows four inductors 4 which differ in size from each other.

However, a different number of inductors having the same size or sizes different from each other may also be provided without departing from the scope of protection of the present invention.

Advantageously, the hob 1 may be flush mounted inside a seat (hole or recess) of a kitchen worktop, not shown in the attached figures; alternatively, the kitchen worktop may be formed by a single sheet, preferably a slab of sintered stone such as Lapitec®, which also defines the hob 1.

In this latter embodiment the kitchen worktop and the hob 1 delimited by the kitchen worktop are joined together in a seamless manner.

Such slab may have a thickness less than or equal to 22 mm, preferably between 10 mm and 14 mm and even more preferably equal to about 12 mm.

The kitchen worktop 1 may also be used in combination with protective elements made of insulating material, not shown in the attached figures, intended to be arranged between the bottom of the saucepans or frying pans and the top surface 2 of the hob 1.

In this connection, the induction hob 1 may be provided with at least one safety device, of the type described in patent application WO2019130180 and not shown in the attached figures, designed to prevent the use of the hob at high temperatures in the absence of the removable protection element.

However, for the reasons indicated in the continuation of the present description, the use of protective elements and the safety device is not essential during use of the hob 1 according to the present invention.

As shown schematically in FIG. 2, the protection assembly 10 intended to be used with the induction hobs in order to prevent overheating thereof comprises preferably:
at least one electric power supplier 8 for electrically powering the at least one inductor 4;
a control unit 11 connected to the at least one power supplier 8.

The protection assembly 10 may also comprise at least one current measuring device 9 associated with the at least one electric power supplier 8 and intended to detect a series of current intensity values at predefined time intervals, the control unit 11 being connected to the at least one current measuring device 9.

The at least one current measuring device 9 is preferably an ammeter and may be configured to wait a first predetermined time interval T1 before detecting the series of current intensity values.

The series of current intensity values detected comprises at least two values and the predefined time intervals may also have a minimum duration so that detection is almost continuous.

Conveniently, the aforementioned components may be positioned opposite the bottom surface of the hob 1 and therefore are not visible during use thereof.

Furthermore, a different number of power suppliers 8 and/or current measuring devices 9 may be provided in the case where the induction hob 1 to be served has more than one inductor 4.

The control unit 11 is configured mainly to:
determine at least one value V of the intensity gradient of the current over time which supplies the at least one inductor 4;
compare the value V of the current intensity gradient over time with a threshold value VSET of the current intensity gradient;
interrupt or reduce the electric power supply provided by the power supplier 8 to the at least one inductor 4 in the case where the value V of the current intensity gradient over time is lower than the threshold value VSET.

In the context of the present description, the expression “current intensity gradient over time” is understood as meaning the variation of the current intensity over time, namely the derivative of the current intensity in relation to time.

The control unit 11 is configured also to receive the current intensity values detected by the at least one current measuring device 9 and to determine the value V of the current intensity gradient based on the current intensity values detected.

The threshold value VSET is determined based on a temperature value of the hob 1 in contact with at least one cooking element containing the food and positioned on the hob 1 for heating.

This temperature value corresponds to the critical temperature reached by the hob 1 in contact with the cooking element, namely the temperature at which the hob 1 overheats and is most susceptible to breakages and damage.

It has been shown in tests that the temperature of the hob 1 in contact with the cooking element increases with a reduction in the value V of the current intensity gradient.

Therefore, when the hob 1 reaches or is about to reach the critical temperature, the value V of the current intensity gradient over time is close to a minimum value corresponding to the threshold value VSET.

For this reason, the protection assembly 10 is configured to interrupt or reduce the electric power supply provided by the power supplier 8 to the at least inductor 4 should the value V of the current intensity gradient fall below the threshold value VSET.

Conveniently, the reduction of the electric power supply to the at least one inductor 4 allows the reduction of the power generated by the inductor 4 opposite the cooking area 6.

The control unit 11 preferably comprises a processing software 12, at least one first algorithm 14 and a second algorithm installed inside it, as shown schematically in FIG. 2, in order to perform the functions indicated above.

These components are in communication with each other during operation of the protection assembly 10 and the control unit 11.

The software 12 is intended preferably to compare the at least one value V of the current intensity gradient and the threshold value VSET and to adjust consequently the operation of the power supplier 8 and therefore the electric power supply to the at least one inductor 4 as described above.

Advantageously, the at least one algorithm 14 is configured to determine the at least one value V of the current intensity gradient over time, preferably based on the series of current intensity values detected by the at least one current measuring device 9.

Furthermore, the threshold value VSET of the current intensity gradient may be fixed (VSET1) or variable (VSET2).

In the first case, the fixed threshold value VSET1 may be established empirically by means of preliminary tests for use of the induction hob 1 which comprises the protection assembly 10; said threshold value VSET1 is loaded into the control unit 11 before use of the protection threshold 10 and the hob 1.

The empirical determination of the fixed threshold value VSET1 by means of the preliminary tests may involve, for example, the detection of the current intensity and its gradient when the hob in contact with the cooking element reaches a temperature which corresponds to the critical temperature of the hob 1 for each of the cooking types to be used.

The fixed threshold value VSET1 is preferably used in order to pass the performance tests carried out on the hob 1 as described above, namely the test which involves the heating of four empty saucepans and the test which involves heating of a saucepan containing oil.

During the performance tests, the protection assembly 10 is configured to interrupt the electric power supply provided by the power supplier 8 to the at least one inductor 4 in the case where the value V of the current intensity gradient reaches a value lower than the fixed threshold value VSET1.

In the second case the threshold value VSET2 is, as stated, variable. In this configuration the threshold value VSET2 is calculated automatically by means of the second algorithm 16 of the control unit 11 indicated above.

In particular, this variable threshold value VSET2 is calculated preferably based on the current intensity values detected by the at least one current measuring device 9 and transmitted to the control unit 11.

This operating mode is used preferably during the usual cooking of food and preferably involves the reduction of the electric power supply by the power supplier 8 to the at least one inductor 4, instead of the interruption of the electric power supply as indicated above, should the value V of the current intensity gradient over time become lower than the threshold value VSET2.

This measure becomes necessary since the cooking processes are of a varying and different nature; therefore, for the various cooking processes there are various threshold values which depend for example on the type of saucepan or frying pan used, the type of food to be cooked and the degree of filling of the saucepan or the frying pan.

The automatic calculation of the variable threshold value VSET2 by the second algorithm 16 of the control unit 11 allows the operation of the hob 1 to be adjusted to the various cooking conditions.

However, the automatic calculation of the threshold value VSET2 may also be performed during the use of the hob 1 with the protection assembly 10 in order to carry out and pass the performance tests carried on the hob 1 of the type described above.

Advantageously, the protection assembly 10 is configured not to alter the operation of the hob 1 if the value V of the current intensity gradient is higher than the threshold value VSET, at least after a predetermined time interval as explained in detail below.

The protection assembly 10 may also comprise a sensor, preferably an NTC probe, intended to detect the temperature of the hob 1 and to be used in combination with the other components described above. Said temperature sensor is not shown in the attached figures.

Moreover, the control unit 11 may be configured to determine a value V of the impedance gradient over time for the at least one inductor 4 based on the current intensity values detected by the at least one current measuring device 9.

The impedance is the force of opposition of the circuit to the through-flow of an alternating electric current and may also be calculated by means of suitable algorithms based on the series of current intensity values detected.

The impedance gradient also varies, as the current intensity gradient, upon variation of the temperature of the hob 1 in contact with the cooking element.

It is also possible to provide saucepans or frying pans comprising means for measuring the temperature of the saucepans or the frying pans (via measurement of the impedance) so as to allow the automatic cooking of the food by controlling the temperature of the saucepans or the frying pans.

As already mentioned, the present invention also relates to a protection method for preventing overheating of hobs 1, which uses the protection assembly 10 described above.

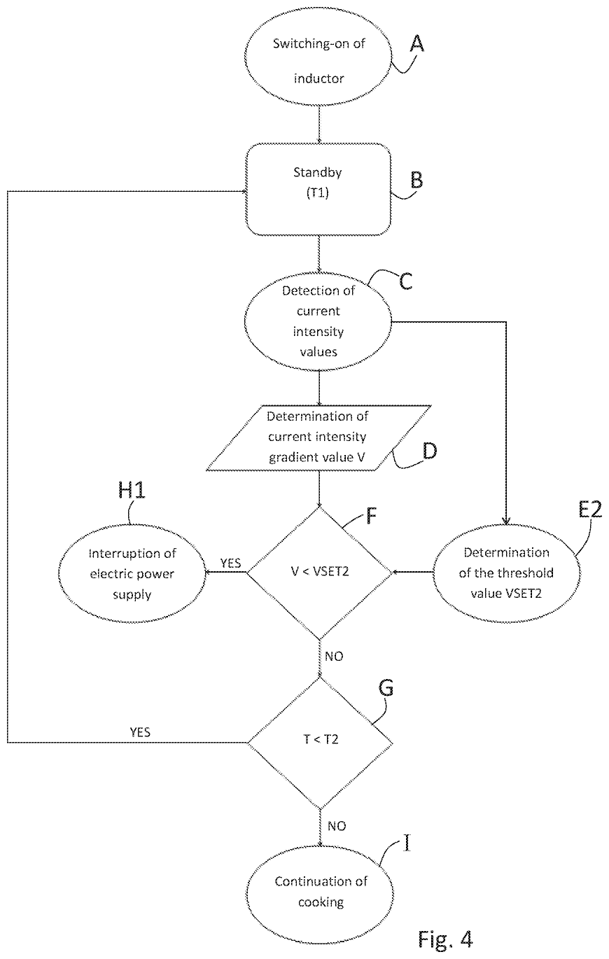

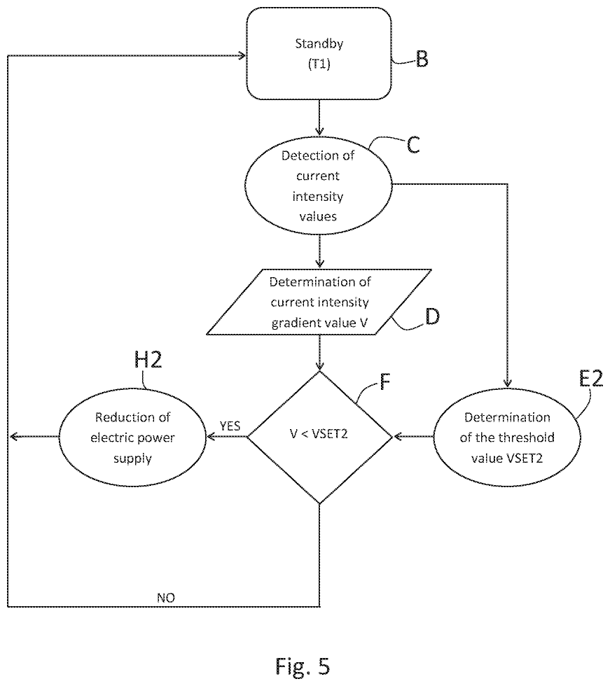

FIGS. 3, 4 and 5 illustrate by means of flow diagrams three different embodiments of the protection method for hobs 1; in particular:
the flow diagrams in FIGS. 3 and 4 illustrate the application of the method preferably during the use of the hobs for the performance tests described above or in any case at the start of a cooking process; the two diagrams differ from each other solely in terms of the different mode of determining the threshold value VSET, as explained below;
the flow diagram in FIG. 5 illustrates the application of the method preferably during use of the hob for the usual cooking of food; this use of the hob 1 may be realized as a continuation of the use of the hob 1 in the manner illustrated in FIG. 4.

The method preferably comprises the following steps:
i) determining at least one value V of the intensity gradient of the current over time which supplies the at least one inductor 4, preferably by means of the first algorithm 14 of the control unit 11;
ii) determining the threshold value VSET of the current intensity gradient;
iii) comparing the value V of the current intensity gradient determined in step i) and the threshold value VSET determined in step ii) by means of the control unit 11, in particular by means of the processing software 12;
iv) interrupting or reducing the electric power supply to the at least one inductor 4 should the value V of the current intensity gradient be lower than the threshold value VSET.

Advantageously, the method also comprises a step of detecting a series of values of the intensity of the current supplied to the at least one inductor 4 at predefined time intervals, performed before the step i).

This step is performed preferably by means of the at least one current measuring device 9 of the protection assembly 10; the determination of the value V of the current intensity gradient over time during step i) is performed preferably based on the detected current intensity values.

The detection step is preceded by a step of arranging a cooking element on a cooking area 6 of the induction hob 1 so as to perform heating thereof and by a step of switching on the at least one inductor 4 of the hob 1 by means of the electric powering of the inductor 4 by the at least one power supplier 8 selectively activated by the user by using suitable means of the known type.

These further steps are also shown in the flow diagrams of FIGS. 3 and 4.

The considerations regarding the determination of the fixed threshold value VST1 or variable threshold value VSET2, based on the critical temperature of the hob in contact with the cooking element, are the same as those described above with reference to the protection assembly 10.

In particular the threshold value VSET1 used in the method of FIG. 3 is fixed and is loaded in the control unit 11 of the assembly 10 after being empirically established as described above.

In this connection, the step ii) of determining the threshold value VSET1, although having been indicated as being carried out after step i), may also be carried prior to the detection step.

The threshold value VSET2 used in the methods illustrated in FIGS. 4 and 5 is variable and is calculated automatically by the control unit 11, in particular by the at least one second algorithm 16 described above.

As already mentioned, the use of the hob 1 illustrated in FIGS. 3 and 4 in both cases involves the interruption of the electric power supply to the at least one inductor 4 during step iv) if the value V of the current intensity gradient over time is lower than the threshold value VSET.

On the other hand, if the value V of the current intensity gradient is higher than the threshold value VSET the use of the hob 1 and therefore cooking of the food may continue as shown in FIG. 5.

Advantageously, the method comprises a standby step for a first predetermined time interval T1 carried out before the step i) and before the detection step.

This predetermined time interval T1 may be preferably approximately five seconds.

During use of the hob 1 as illustrated in FIG. 5, it is envisaged performing the periodic repetition of the standby step, the detection step and the steps i)-iii); however, the protection assembly 10 may intervene at each repetition, reducing the electric power supply to the at least one inductor 4 if the value V of the current intensity gradient is lower than the threshold value VSET2.

If the value V of the current intensity gradient is higher than the threshold value VSET2 during the method illustrated in FIG. 5, cooking of the food continues until the user independently interrupts the electric power supply to the at least one inductor 4 by means of the selective activation means at the end of the cooking process.

The embodiments of the method illustrated in FIGS. 3 and 4 also envisage defining a second predetermined time interval T2, which is preferably about 3 minutes.

The durations of the first time interval T1 and the second time interval T2 may also be different from those indicated above, without thereby departing from the scope of protection of the present invention.

As shown in FIGS. 3 and 4, the method involves the repetition of the standby step, the detection step and the steps i)-iii) in the case where the value V of the current intensity gradient value is higher than the threshold value VSET and the time T lapsed from the start of the detection step is less than the second predetermined time interval T2.

If the value V of the current intensity gradient over time is lower than the threshold value VSET and the time T lapsed from the start of the detection step is less than the second predetermined time interval T2 the electric power supply to the at least one inductor 4 is interrupted.

If, instead, the value V of the current intensity gradient is higher than the threshold value VSET and the time T lapsed from the start of the detection step is greater than the second predetermined time interval T2, use of the hob 1 and cooking of the food are continued.

After the second predetermined time interval T2 has lapsed, the standby step, the detection step and steps i)-iii) are repeated if the value V of the current intensity gradient over time is higher than the threshold value VSET, or the electric power supply to the at least one inductor 4 is reduced if the value V of the current intensity gradient over time is lower than the threshold value VSET.

Advantageously, the step of detecting a series of current intensity values at predefined intervals is performed, not only in order to determine the current intensity gradients, but also to determine and calculate the impedance gradient value over time, namely the variation of the impedance over time.

The method may also comprise a step of automatically interrupting the electric power supply of the at least one inductor 4 should the electric power detected for the circuit be less than a predetermined threshold value of the electric power.

This measure is particularly useful in the case where the user forgets about the empty saucepans or frying pans on the working hob 1 after the second time interval T2 has lapsed.

With reference to the flow diagrams shown in FIGS. 3-5:
the blocks relating to switching-on of the at least one inductor 4 are indicated overall by the reference letter A;
the blocks relating to the standby step for a predetermined first time interval T1 are indicated overall by the reference letter B;
the blocks relating to the step of detecting the current intensity values are indicated overall by the reference letter C;
the blocks relating to step i) of determining the value V of the current intensity gradient, preferably by means of the first algorithm 14, are indicated overall by the reference letter D;
the blocks relating to step ii) of determining the threshold value VSET are indicated respectively by the reference E1 in FIG. 3 (in which the threshold value VEST1 is fixed and determined empirically) and by the reference E2 in FIGS. 4 and 5 (in which the threshold value VSET2 is variable and is calculated automatically by means of the second algorithm 16);
the blocks relating to step iii) of comparing the current intensity gradient value V with the threshold value VSET are indicated overall by the reference letter F;
the blocks relating to the step of evaluating the time T lapsed with respect to the second predetermined time interval T2 are indicated overall by the reference letter G;
the blocks relating to step iv) of interrupting the electric power supply to the at least one inductor 4 are indicated overall by H1 in FIGS. 3 and 4; the block relating to step iv) of reducing the electric power supply to the at least one inductor 4 is indicated by the reference H2 in FIG. 5;
the blocks relating to continuation of use of the hob 1 and cooking of the food in FIGS. 3 and 4 are indicated overall by the reference letter I.

From the above description it is now clear how the protection assembly and the method according to the present invention are able to achieve advantageously the predefined objects.

In particular, the use of the protection assembly is able to prevent in an effective manner overheating and therefore breakage and damaging of the hob.

Moreover, the protection assembly is able to prevent overheating of the hob for various type of cooking and cooking conditions and ensure passing of the known performance tests for hobs.

The protection assembly according to the present invention also offers the advantage that it may be used in combination with various types of hobs, even though the preferred use remains that with a hob made of sintered stone such as Lapitec®.

Obviously, the above description of embodiments applying the innovative principles of the present invention is provided by way of example of these innovative principles and must therefore not be regarded as limiting the scope of the rights claimed herein.

1. A protection assembly for preventing overheating of induction hobs comprising at least one inductor with a respective circuit arranged below a cooking area of the hobs, the assembly comprising:
at least one electric power supplier for electrically supplying the at least one inductor;
a control unit connected to said at least one power supplier;
characterized in that said control unit is configured to determine at least one value of the intensity gradient of the current over time which supplies said at least one inductor, to compare said value of the current intensity gradient over time with a threshold value of the current intensity gradient over time, and to interrupt or reduce the electric power supply to said at least one inductor if the value of the current intensity gradient is lower than the threshold value.

2. The protection assembly according to claim 1, characterized in that it comprises at least one current measuring device associated with said at least one electric power supplier and intended to detect a series of current intensity values at predefined time intervals.

3. The protection assembly according to claim 2, characterized in that said control unit is connected to said at least one current measuring device and is configured to receive the current intensity values detected by said at least one current measuring device and to determine the value of the current intensity gradient over time based on said current intensity values detected.

4. The protection assembly according to claim 1, characterized in that the control unit comprises at least one first algorithm for determining the at least one value of the current intensity gradient over time.

5. The protection assembly according to claim 1, characterized in that the threshold value of the current intensity gradient over time is fixed and loaded into said control unit.

6. The protection assembly according to claim 2, characterized in that said control unit comprises at least one second algorithm for calculating the threshold value of the current intensity gradient based on the current intensity values detected by said at least one current measuring device, said threshold value being variable.

7. The protection assembly according to claim 2, characterized in that said at least one current measuring device is configured to wait for a first predetermined time interval before detecting the series of current intensity values.

8. The protection assembly according to claim 1, characterized in that said control unit is configured to determine a value of the impedance gradient over time for said at least one inductor based on the current intensity values detected.

9. An induction hob comprising:
at least one inductor arranged below a cooking area of the hob;
a protection assembly according to claim 1.

10. A protection method for preventing overheating of an induction hob comprising at least one inductor located below a cooking area of the hob and a protection assembly, comprising the following steps:
(i) determining at least one value of the intensity gradient of the current over time which supplies said at least one inductor over time;
(ii) determining a threshold value of the current intensity gradient over time;
(iii) comparing the value of the current intensity gradient determined in said step (i) and the threshold value determined in said step (ii);
(iv) interrupting or reducing the electric power supply to said at least one inductor if the value of the current intensity gradient is lower than said threshold value.

11. The protection method according to claim 10, characterized in that said threshold value is determined based on a temperature value of the hob in contact with a cooking element corresponding to a critical temperature of the hob.

12. The protection method according to claim 10, further comprising a step of detecting a series of values of the intensity of the current supplied to said at least one inductor at predefined time intervals, said detection step being performed before said step (i).

13. The protection method according to claim 12, characterized in that said step (i) of determining the value of the current intensity gradient is performed by means of a first algorithm of said protection assembly based on the current intensity values detected.

14. The protection method according to claim 10, characterized in that the threshold value of the current intensity gradient is fixed and is established by means of preliminary tests regarding use of the induction hob.

15. The protection method according to claim 12, characterized in that the threshold value of the current intensity gradient is variable and is calculated by means of at least one second algorithm of said protection assembly based on the current intensity values detected.

16. The protection method according to claim 12, characterized in that a standby step for a first predetermined time interval is provided before said detection step.

17. The protection method according to claim 16, characterized by defining a second predetermined time interval and by performing the repetition of said standby step, said detection step and said steps (i)-(iii) if the value of the current intensity gradient is higher than the threshold value and the time lapsed from the start of said detection step is less than the second predetermined time interval, or by interrupting the electric power supply to said at least one inductor if the value of the current intensity gradient over time is lower than the threshold value and the time lapsed from the start of said detection step is less than the second predetermined time interval.

18. The protection method according to claim 16, characterized by defining a second predetermined time interval and by continuation of use of the hob if the value of the current intensity gradient is higher than the threshold value and the time lapsed from the start of said detection step is greater than the second predetermined time interval.

19. The protection method according to claim 17, characterized in that, once said second predetermined time interval has lapsed, said standby step, said detection step and said steps (i)-(iii) are repeated if the value of the current intensity gradient over time is higher than the threshold value, or the electric power supply to said at least one inductor is reduced if the value of the current intensity gradient over time is lower than the threshold value.

20. The protection method according to claim 10, characterized by providing a step of automatically interrupting the electric power of the at least one inductor if the electric power detected for the at least one inductor is lower than a predetermined threshold value of the electric power.

21. The protection method according to claim 18, characterized in that, once said second predetermined time interval has lapsed, said standby step, said detection step and said steps (i)-(iii) are repeated if the value of the current intensity gradient over time is higher than the threshold value, or the electric power supply to said at least one inductor is reduced if the value of the current intensity gradient over time is lower than the threshold value.
